(19) United States
(12) Patent Application Publication
(10) Pub. No.: US 2011/0032816 A1
(43) Pub. Date: Feb. 10, 2011

(54) Connection Failure Notification Method And Apparatus

(75) Inventors: Niklas Isaksson, Molnlycke (SE); Per Ståhle, Stockholm (SE); Magnus Standar, Floda (SE); Andreas Olsson, Stockholm (SE)

Correspondence Address: ERICSSON INC., 6300 LEGACY DRIVE, M/S EVR 1-C-11, PLANO, TX, 75024, US

(73) Assignee: TELEFONAKTIEBOLAGET L M ERICSSON (PUBL), Stockholm (SE)

(21) Appl. No.: 12/744,755

(22) PCT Filed: Nov. 28, 2007
(86) PCT No.: PCT/SE07/50908

§ 371 Date: Oct. 25, 2010

(51) Int. Cl. H04W 40/00

(52) U.S. Cl. 370/225

(57) ABSTRACT

An access point according to the present invention generates and broadcasts a notification message to the mobile devices serviced by an access point upon detection of a connection failure between the serving access point and a network node. The notification message controls the impact of the connection failure on neighboring cells by including redirect information that identifies one or more alternate access points for the affected mobile devices. The affected mobile devices subsequently attempt to access the access points identified by the redirect information. The notification message may also include timing information that informs the affected mobile devices when they may attempt to access an alternate access point identified by the redirect information.

### TECHNICAL FIELD

The present invention relates generally to transmission interface failures between network nodes in a wireless communication system.

### BACKGROUND

Wireless communication systems typically include multiple wireless networks that rely on different radio access technologies to exchange information between a core network and a mobile device, such as a cellular telephone. In general, the mobile device communicates with an access point in one of the wireless networks according to the radio access technology associated with the wireless network, e.g., GSM, UMTS, LTE, etc. The access point in turn communicates with the core network according to the appropriate radio access technology. Such communications operate without interruption as long as the communication link(s) between the mobile device and the core network are maintained. A failure in one or more of the communication links jeopardizes the ongoing communications between the mobile device and the core network.

For example, when operating in a UMTS network, the mobile device communicates with a NodeB access point. The NodeB in turn communicates with the core network via a Radio Network Controller (RNC). A failure in the communication link between the NodeB and the RNC, or between the RNC and the core network prevents the NodeB from operating properly. Similarly, when operating in an LTE network, a failure in the communication link between the eNodeB access point and the core network prevents the eNodeB access point from working properly.

When prior art networks encounter this problem, the affected mobile devices enter an idle mode. During idle mode operation, the mobile devices may attempt to access a different access point to reestablish communications with the core network. In some cases, one or more of the mobile devices may attempt to access an access point associated with a different radio access technology. Alternatively or additionally, some or all of the mobile devices may attempt to simultaneously access the same access point in a neighboring cell. These types of transitions may put an undesirably large strain on the affected neighboring cells. Further, functionality to have optimized neighbor cell relations in a network may be based on UE measurements on neighbor cells. A failure in the communication link between the access point and the core network may impact this functionality.

### SUMMARY

The present invention addresses connection failures between an access point and a network node, such as the core network, in a wireless communication system. More particularly, a connection processor in an access point monitors a connection between the access point and the network node. Upon detection of a connection failure, the connection processor generates and broadcasts a notification message to the mobile devices serviced by the access point. According to one exemplary embodiment, the notification message includes redirect information that identifies one or more alternate access points for the affected mobile devices. The redirect information enables the affected access point to control the impact of the connection failure on neighboring cells. Further, the redirect information enables the affected access point to dictate the type of access point(s), and therefore the particular radio access technology, utilized by the affected mobile devices. The mobile devices subsequently attempt to access the access points identified by the redirect information. By providing redirect information with a connection failure notification message, the present invention advantageously provides means for protecting neighbor cells from overload, prevents the affected mobile devices from attempting to use a different radio access technology, and enables the mobile devices to avoid entering the idle mode.

The notification message may also include timing information that informs the affected mobile devices when they may attempt to access an alternate access point identified by the redirect information. For example, the timing information may provide a specific redirection time for some or all of the mobile devices. Thus, the timing information advantageously controls the redirection of the affected mobile devices to prevent multiple mobile devices from redirecting at the same time. Alternatively, the timing information may instruct some or all of the mobile devices to wait for a second notification message before attempting to access an alternate access point. In this case, the second notification message may control the redirection time by explicitly instructing a mobile device to begin the access attempt. Alternatively, the second notification message may notify a mobile device that the original serving access point has reestablished connection with the core network, and therefore, that no redirection is required. In this case, the second notification message advantageously informs the affected mobile devices that no redirection is needed.

### BRIEF DESCRIPTION OF THE DRAWINGS

FIG. 1 shows a wireless communication system applicable to the present invention.

FIG. 2 shows an exemplary process according to the present invention.

FIG. 3 shows an exemplary block diagram of an access point in the wireless communication system of FIG. 1.

### DETAILED DESCRIPTION

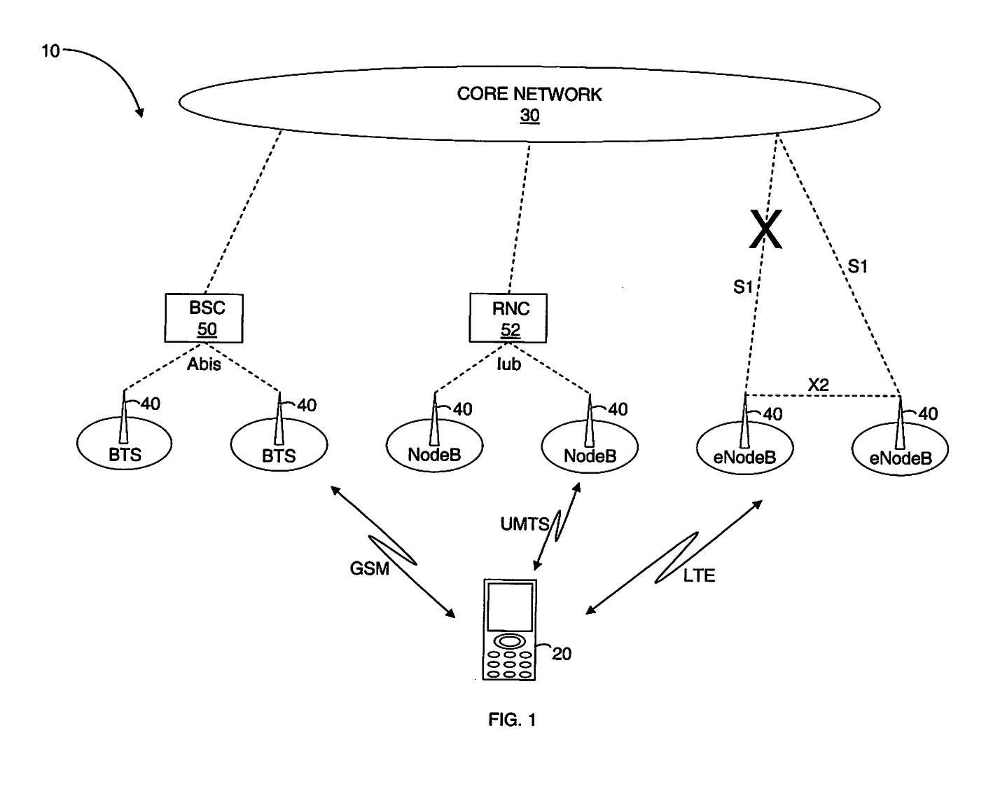

FIG. 1 shows one exemplary wireless communication system 10. The wireless communication system 10 includes one or more access points 40 that enable wireless communications with mobile devices 20, such as mobile telephones, personal digital assistants, laptop computers, etc. The access points 40 may implement the same access technology, or may implement different access technologies. For a GSM network, the access point 40 comprises a Base Transceiver Station (BTS), while for UMTS and LTE networks, the access point 40 comprises a NodeB and an eNodeB, respectively. While not shown, other access points 40, e.g., a WLAN access point, may be included in wireless communication system 10. The access points 40 connect the mobile device 20 to a core network 30. For a GSM network, the BTS 40 connects to a Base Station Controller (BSC) 50 over an Abis interface, and the BSC 50 in turn connects to the core network 30. For a UMTS network, the NodeB 40 connects to a Radio Network Controller (RNC) 52 over an lub interface, and the RNC 52 in turn connects to the core network 30. For an LTE network, the eNodeB connects to a serving gateway and mobility management entity in the core network 30 via an S1 interface.

When the connection between an access point 40 and the core network 30 is interrupted or fails, e.g., as shown with the LTE network in FIG. 1, the affected access point 40 is typically removed from service and mobile devices 20 served by the removed access point 40 switch to an idle mode. During idle mode, the mobile devices 20 select and attempt to access a new access point 40 as soon as possible to reestablish communications with the core network 30.

The mobile devices 20 may select an access point 40 using a different radio access technology than the originally serving access point 40. Further, the abrupt transition of multiple mobile devices 20 to a new access point 40 may undesirably overload neighboring access points 40.

According to embodiments of the present invention, an access point 40 monitors the state of its connection to the core network 30 and broadcasts a notification to the mobile devices 20 when the connection is interrupted or fails. The access point 40 may also broadcast redirect information to the mobile devices 20 to indicate the preferred access points 40 available for reselection by the mobile devices 20. The redirect information may also indicate specific times when the mobile devices 20 should switch to the neighboring access points 40. Thus, the mobile devices 20 may be “scheduled” so that large numbers of mobile devices 20 do not all switch to the same neighboring access point 40 at the same time.

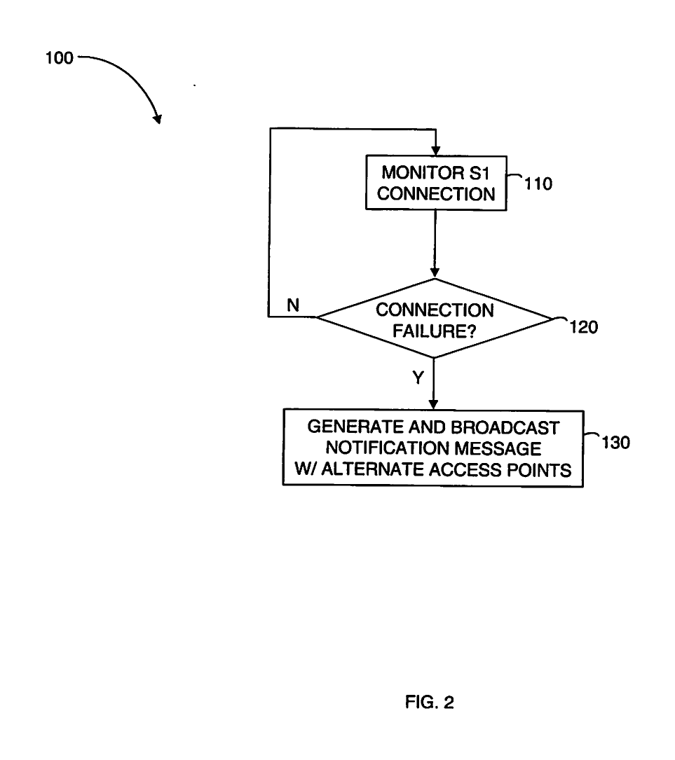

FIG. 2 illustrates an exemplary method 100 implemented by an access point 40. The serving access point 40 monitors the connection between the access point 40 and the core network 30 (block 110). Upon detection of a connection failure (block 120), the access point 40 generates and broadcasts a notification to the mobile devices 20 (block 130) indicating that the access point is out-of-service. The broadcasted notification includes redirect information that identifies one or more alternate access points 40 available for reselection by the mobile devices 20. For example, the redirect information may identify an access point 40 of a neighboring cell. The redirect information may also include scheduled times for the mobile devices 20 to switch to the neighboring access points 40.

Access points 40 may generate the redirect information of the notification message based on any available neighboring cell information. For example, a serving access point 40 may identify multiple alternate access points 40 based on the number of mobile devices 20 currently under the control of the serving access point 40, the current load of neighboring access points 40, etc. It will be appreciated that some or all of the load information required to generate the redirect information may be provided by the neighboring access points 40 via an interface between the access points, e.g., an X2 interface, and/or by the mobile devices 20. Regardless, the broadcasted notification message identifies specific alternate access points 40 available to the mobile devices 20 affected by the connection failure.

Responsive to the notification message, the mobile devices 20 attempt to access one of the alternate access points 40 identified by the broadcasted notification message to continue communications with the core network 30. It will be appreciated that the redirect information may identify specific alternate access points 40 for specific mobile devices 20. For example, the redirect information may specify that one mobile device 20 should access a first alternate access point 40, and that another mobile device 20 should access a second alternate access point 40. Alternatively, each mobile device 20 may select one of the access points 40 identified by the redirect information according to some predetermined criteria. For example, a mobile device 20 may select one of the identified access points 40 by selecting the closest identified access point 40. In any event, the redirect information controls which alternate access points 40 are accessed by the mobile devices 20 in the event of a connection failure at the serving access point 40.

While not required, the broadcasted notification message may include timing information that controls when some or all of the mobile devices 20 may attempt to access an alternate access point 40 identified by the redirect information. For example, the timing information may identify a designated access time for some or all of the mobile devices 20, where each mobile device 20 attempts to access an alternate access point 40 at its designated access time. Alternatively, the timing information may instruct some or all of the mobile devices 20 to wait for a second notification message before attempting to access an alternate access point 40. In this case, the serving access point 40 may delay transmission of the second notification message to delay the transitions of the mobile devices 20 to the alternate access points 40. Thus, the second notification message may be used to control when each mobile device 20 transitions to an alternate access point 40.

In still another example, where the timing information instructs some or all of the mobile devices 20 to wait for a second notification message, the access point 40 may delay sending the second notification message a predetermined time period while it attempts to reestablish the connection with the core network 30. If the access point 40 is successful, the second notification message may inform some or all of the mobile devices 20 that the connection has been reestablished, which effectively cancels the first notification message. If the access point 40 is not successful within the predetermined time period, the access point 40 may delay transmission of the second notification message to delay the transitions of the mobile devices 20 to the alternate access points 40, and therefore, to control when each mobile device 20 transitions to an alternate access point 40.

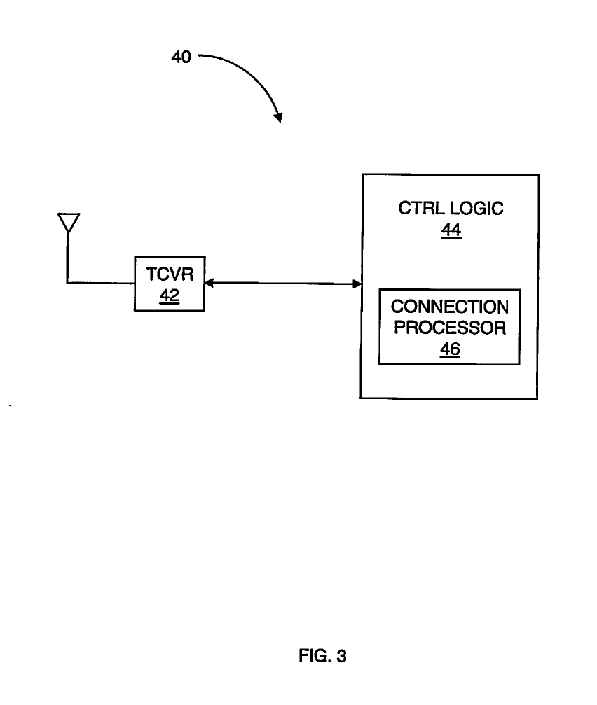

FIG. 3 shows an exemplary block diagram of an access point 40 according to the present invention. The access point includes a transceiver 42 and control logic 44. The transceiver connects to an antenna that wirelessly communicates with the mobile devices 20 according to instructions provided by the control logic 44. The control logic further includes a connection processor 46 that implements the above-described process for notifying a mobile device 20 of a connection failure between the access point 40 and the core network 30.

The above-described invention addresses the issues associated with prior art solutions for connection failures between an access point 40 and a core network 30 in a wireless communication system 10. By directing the mobile devices 20 affected by the connection failure to specific alternate access points 40, the present invention controls the impact of the connection failure on neighboring cells. Further, the present invention may prevent multiple mobile devices 20 from simultaneously attempting to access one access point 40 by providing means for controlling the timing associated with the transition of the mobile devices 20 to alternate access points 40. Further still, the present invention enables one access point 40 to continue to dynamically keep track of other access points 40. For example, in conventional systems, an access point 40 associated with a connection failure may be deleted from the neighbor lists of neighboring access points 40 due to a lack of proposed neighbors from mobile device measurements for an access point 40 associated with a connection failure. The present invention allows the affected access point 40 to stay on the neighbor lists of the neighboring access points 40 with the understanding that the affected access point 40 is unavailable until the connection is restored. In this case, one or more of the affected mobile devices 20 may report the connection failure to one or more neighboring access points.

The present invention may, of course, be carried out in other specific ways than those herein set forth without departing from the scope and essential characteristics of the invention. The present embodiments are, therefore, to be considered in all respects as illustrative and not restrictive, and all changes coming within the meaning and equivalency range of the appended claims are intended to be embraced therein.

What is claimed is:

1. A method of notifying mobile devices of a connection failure between an access point and a network node in a wireless communication system, the method comprising:
detecting a connection failure for an interface between the access point and the network node; and
generating and broadcasting a notification message responsive to the connection failure to notify mobile devices serviced by the access point of the connection failure, wherein the notification message includes redirect information that identifies one or more alternate access points for the mobile devices.

2. The method of claim 1 wherein the notification message includes timing information identifying when one or more of the mobile devices should redirect to an alternate access point.

3. The method of claim 2 wherein the timing information comprises redirection times for one or more of the mobile devices.

4. The method of claim 2 wherein the timing information instructs one or more of the mobile devices to wait for second notification message before redirecting to one of the alternate access points.

5. The method of claim 4 further comprising transmitting the second notification message to one or more of the mobile devices at different times.

6. The method of claim 4 further comprising:
reconfiguring the interface to reestablish the connection between the access point and the network node; and
broadcasting the second notification message to the mobile devices to notify the mobile devices of the reestablished connection to overturn the pending redirection operation.

7. The method of claim 1 further comprising:
reconfiguring the interface to reestablish the connection between the access point and the network node; and
broadcasting a second notification message regarding the reestablished connection.

8. An access point in a wireless communication system, the access point comprising a connection processor configured to:
detect a connection failure for an interface between the access point and a network node in the wireless communication system; and
generate and broadcast a notification message responsive to the connection failure to notify mobile devices serviced by the access point of the connection failure, wherein the notification message includes redirect information that identifies one or more alternate access points for the mobile devices.

9. The access point of claim 8 wherein the notification message includes timing information identifying when one or more of the mobile devices should redirect to an alternate access point.

10. The access point of claim 9 wherein the timing information comprises redirection times for one or more of the mobile devices.

11. The access point of claim 9 wherein the timing information instructs one or more of the mobile devices to wait for second notification message before redirecting to one of the alternate access points.

12. The access point of claim 11 wherein the connection processor is further configured to transmit the second notification message to one or more of the mobile devices at different times.

13. The access point of claim 11 wherein the connection processor is further configured to:
reconfigure the interface to reestablish the connection between the access point and the network node; and
broadcast the second notification message to the mobile devices to notify the mobile devices of the reestablished connection to overturn the pending redirection operation.

14. The access point of claim 8 wherein the connection processor is further configured to:
reconfigure the interface to reestablish the connection between the access point and the network node; and
broadcast a second notification message regarding the reestablished connection.

15. A method of notifying a mobile device of a connection failure between an access point and a network node in a wireless communication system, the method comprising:
receiving a broadcasted notification message indicating a connection failure between the access point and the network node, wherein the notification message includes redirect information identifying one or more alternate access points for the mobile device; and
using the redirect information to access one of the alternate access points.

16. The method of claim 15 wherein the notification message includes timing information identifying when the mobile device should redirect to one of the alternate access points.

17. The method of claim 16 wherein using the redirect information to access one of the alternate access points comprises using the redirect information to access one of the alternate access points at an explicit redirection time identified by the timing information.

18. The method of claim 16 wherein the timing information instructs the mobile device to delay accessing one of the alternate access points until a second notification message is received.

19. The method of claim 18 wherein the second notification message informs the mobile device of a reestablished connection between the access point and the network node.

20. The method of claim 15 further comprising reporting the connection failure to one or more alternate access points.

21. A mobile device operatively associated with an access point in a wireless communication system, the mobile device method comprising a processor configured to:
receive a broadcasted notification message indicating a connection failure between the access point and a network node in the wireless communication system, wherein the notification message includes redirect information identifying one or more alternate access points for the mobile device; and
use the redirect information to access one of the alternate access points.

22. The mobile device of claim 21 wherein the notification message includes timing information identifying when the mobile device should redirect to one of the alternate access points.

23. The mobile device of claim 22 wherein the processor use the redirect information to access one of the alternate access points at an explicit redirection time identified by the timing information.

24. The mobile device of claim 22 wherein the timing information instructs the mobile device to delay accessing one of the alternate access points until a second notification message is received.

25. The method of claim 24 wherein the second notification message informs the mobile device of a reestablished connection between the access point and the network node.
